(19) United States
(12) Patent Application Publication
(10) Pub. No.: US 2008/0197172 A1
(43) Pub. Date: Aug. 21, 2008

(54) Bonding Tool

(76) Inventor: Steven F. Reiber, Rocklin, CA (US)

Correspondence Address: CARR & FERRELL LLP, 2200 GENG ROAD, PALO ALTO, CA, 94303, US

(21) Appl. No.: 12/026,551

(22) Filed: Feb. 5, 2008

Related U.S. Application Data
(63) Continuation-in-part of application No. 11/227,982, filed on Sep. 14, 2005.
Application No. 11/227,982 is a continuation-in-part of application No. 11/107,308, filed on Apr. 15, 2005, now Pat. No. 7,124,927.
Application No. 11/107,308 is a continuation-in-part of application No. 10/942,311, filed on Sep. 15, 2004, now Pat. No. 7,389,905.
Application No. 11/107,308 is a continuation-in-part of application No. 10/943,151, filed on Sep. 15, 2004, now Pat. No. 7,032,802.
Application No. 10/942,311 is a continuation-in-part of application No. 10/650,169, filed on Aug. 27, 2003, now Pat. No. 6,935,548.
Application No. 10/943,151 is a continuation-in-part of application No. 10/650,169, filed on Aug. 27, 2003, now Pat. No. 6,935,548.
Application No. 10/650,169 is a continuation of application No. 10/036,579, filed on Dec. 31, 2001, now Pat. No. 6,651,864.
Application No. 10/036,579 is a continuation-in-part of application No. 09/514,454, filed on Feb. 25, 2000, now Pat. No. 6,354,479.
(60) Provisional application No. 60/888,284, filed on Feb. 5, 2007.
(60) Provisional application No. 60/888,517, filed on Feb. 6, 2007.
(60) Provisional application No. 60/610,847, filed on Sep. 17, 2004.
(60) Provisional application No. 60/503,267, filed on Sep. 15, 2003.
(60) Provisional application No. 60/288,203, filed on May 1, 2001.
(60) Provisional application No. 60/121,694, filed on Feb. 25, 1999.

(51) Int. Cl. B23K 37/00; B23K 31/00

(52) U.S. Cl. 228/180.5; 228/4.5

(57) ABSTRACT

Means to increase the UPH of TAB bonding on an HSA manufacturing line to allow a higher UPH to keep cost down and also allow the use of one or more grounds to be add to an HSA to help control ESD without lowering the UPH or redesigning the lines through the use of a multi-head contact TAB bonding tool as described herein A bonding tool for use in tape automated bonding (TAB) is provided that is for multi-contact. The multi-contact TAB bonding tool is ESD safe so as not to damage a device being bonded.

### CROSS-REFERENCE TO RELATED APPLICATIONS

The present application claims the priority benefit of U.S. provisional patent application No. 60/888,284 filed Feb. 5, 2007 and entitled “Multi-Head-Contact TAB Bonding Tool” and U.S. provisional patent application No. 60/888,517 filed Feb. 6, 2007 and entitled “Multi-Contact TAB Bonding Tool”; the present application is also a continuation-in-part of U.S. patent application Ser. No. 11/227,982 filed Sep. 14, 2005 and entitled “Multi-Head TAB Bonding Tool,” which claims the priority benefit of U.S. provisional patent application No. 60/610,847 filed Sep. 17, 2004 and entitled Multi-Head TAB Bonding Tool”; U.S. patent application Ser. No. 11/227,982 is also a continuation-in-part and claims the priority benefit of U.S. patent application Ser. No. 11/107,308 filed Apr. 15, 2005 and entitled “Flip Chip Bonding Tool and Ball Placement Capillary,” which is a continuation-in-part and claims the priority benefit of U.S. patent application Ser. No. 10/942,311 filed Sep. 15, 2004 and entitled “Flip Chip Bonding Tool Tip”; U.S. patent application Ser. No. 11/107,308 is also a continuation-in-part and claims the priority benefit of U.S. patent application Ser. No. 10/943,151 filed Sep. 15, 2004 and entitled “Bonding Tool with Resistance”; U.S. patent application Ser. Nos. 10/942,311 and 10/943,151 are both continuations-in-part and claim the priority benefit of U.S. patent application Ser. No. 10/650/169 Filed Aug. 27, 2003 and entitled “Dissipative Ceramic Bonding Tool Tip,” which is a continuation and claims the priority benefit of U.S. patent application Ser. No. 10/036,579 filed Dec. 31, 2001 entitled “Bonding Tool.” The disclosure of each of the aforementioned applications is incorporated herein by reference.

### BACKGROUND OF THE INVENTION

1. Field of the Invention

This present invention generally concerns bonding tools. More specifically, the present invention concerns multi-head-contact tape automated, bonding (TAB) bonding tools and multi-contact TAB bonding tools.

2. Description of the Prior Art

Tape automated bonding is the process of mounting a die on a flexible tape made of a polymer material such as polymide. The bonding sites of the die, usually in the form of bumps or balls made of gold or solder, are connected to fine conductors on the tape. The conductors connect the die to the package or directly to external circuits. In some instances, the tape of which the die is bonded contains the actual application circuit of the die.

The tape used in the bonding is usually single-sided although two-metal tapes are also available. Copper is a commonly-used, metal in these tapes and may be electro-deposited on the tape or attached using adhesive. Metal patterns of a circuit are imaged onto the tape using photolithography methodologies. The TAB bonds connecting the die and the tape are known as inner lead bonds (ILB). TAB bonds that connect the tape to the package or to external circuits are known as outer lead bonds (OLB). To facilitate the connection, of die bumps or balls to their corresponding leads on a TAB circuit, holes are punched on the tape where the die bumps will be positioned. The conductor traces of the tape are then cantilevered over the punched holes to meet the bumps of the die.

There are two common methods of achieving a bond between the gold bump of the die and the lead of a TAB circuit. In a first method, single-point bonding connects each of the die's bond sites individually to its corresponding lead on the tape. Heat, force, and ultrasonic energy are applied to the TAB lead over time, which is positioned directly over the gold bump forming inter-metallic connections.

Single-point bonding is a more time-consuming process than the second methodology—gang bonding. Gang bonding employs a specially designed bonding tool to apply force and temperature over time to create diffusion bonds between the leads and bumps all at the same time. When used without ultrasonic energy, this type of bonding is referred to as thermo-compression bonding. Gang bonding offers a high throughput rate versus single-point bonding.

When a bonding tip is placed over a flex circuit, a bonding tool will make intimate contact with tabs in a window formed in the flex circuit. The bonding tool ultrasonically flow the TABs onto the bonding pads of the amplifier. Molecular bonds result and produce a reliable electrical and mechanical connection.

FIG. 1A illustrates a plan view of TAB bonding as is known in the art. In FIG. 1A, a polyimide film 110 comprising a series of dual sprockets is provided. The film 110 is moved to a target location and the leads are cut (cut line 120) and soldered to a printed circuit board. ILB 130 go to an IC chip 150 while OLB 140 go to the circuit board. FIG. 1B illustrates a side view of the IC chip and ILB 130 and OLB 140. FIG. 1C illustrates the IC chip 150 having been adhered, and bonded, to the PCB and subsequently coated with an insulative epoxy 160.

TAB bonding is increasingly used in a disk drive for assembly of the Head Stack Assembly (HSA) to the Head Gimbal Assembly (HGA). TAB bonding is used for making electrical connections between a head and an amplifier. The most common TAB tool has been a waffle, an example of a waffle tool is shown in FIG. 2.

TAB bonding offers certain advantages with regard to the use of smaller bond pads and finer bond pitching. The use of bond pads over all of the die instead of the die periphery increases I/O count, reduces the amount of gold required for bonding, and shortens production cycle time. TAB bonding also reduces noise, provides for circuit flexibility, and facilitates multi-chip module manufacturing. But prior art bonding tools, including those made of aluminum oxide or tungsten carbide, lack the sufficient hardness to prevent deformation under pressure and mechanical durability so that many bonds can be made before replacement.

There is, therefore, a need in the art for both a multi-head-contact TAB bonding tool and multi-contact TAB bonding tool. There is a need for these tools to be of sufficient durability and hardness as to avoid the need for constant replacement or deformation from repeated use. There is a further need in the art for a multi-head-contact and multi-contact TAB bonding tools that satisfy durability and hardness demands while still offering a reliable electrical contact while preventing electrostatic discharge (ESD) that may damage an electrical component being bonded.

### SUMMARY OF THE INVENTION

Some embodiments of the present invention advantageously provides for the use of multi-head-contact and multi-contact TAB bonding tools to accelerate the TAB bonding process. An operator may complete an assembly process through the use of, for example, two or three bonding operations instead of the usual four or six bonding operations. Further embodiments of the present invention advantageously provides for an multi-head-contact and multi-contact TAB bonding tools that may be made from a uniform extrinsic material that has the hardness and flexural strength to be utilized in accelerated TAB bonding. Embodiments of the present invention also provide for an exemplary multi-head-contact or multi-contact TAB bonding tool formed by a thin layer of a highly doped semiconductor on an insulating core or, alternatively, a lightly doped semiconductor layer on a conducting core. Embodiments of the present invention also allow for a manufacturing line to accommodate new TAB tools needed to help control ESD without redesigning the manufacturing line.

### BRIEF DESCRIPTION OF THE DRAWINGS

FIG. 1A illustrates a plan view of TAB bonding as is known in the art.

FIG. 1B illustrates a side view of the TAB bonding as described, in FIG. 1B.

FIG. 1C illustrates an IC chip bonding to a PCB using a TAB methodology, the IC chip subsequently covered with an insulative epoxy.

FIG. 2 is an exemplary waffle tool for use in. TAB bonding as is known in the art.

FIG. 3 illustrates a single point TAB tool utilizing a double cross groove and as may be utilized in a multi-head-contact or multi-contact TAB bonding tool.

### DETAILED DESCRIPTION

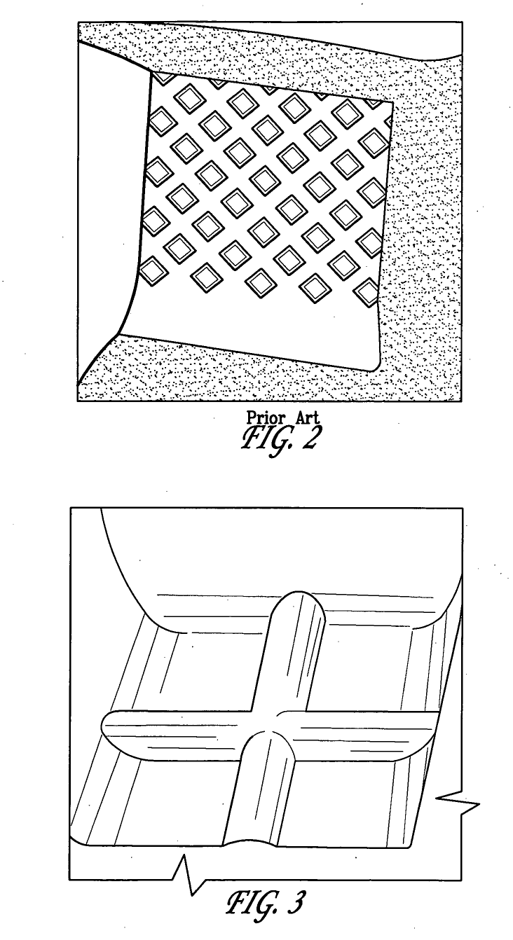

FIG. 3 illustrates a single point Tape Automated Bonding (TAB) tool utilizing a double cross groove according to an embodiment of the present invention and as may be utilized in a multi-head-contact or multi-contact TAB bonding tool. Reference to a double cross groove is not meant to limit the scope of the present TAB tool in that other groove configurations are known in the art and may be utilized. These configurations include but are not limited to a single cross groove, a single point, a protruding ‘V,’ and the aforementioned waffle.

An exemplary multi-head-contact or multi-contact TAB tool may be one-half to three inches (12-80 mm) long and approximately one-sixteenth to one-eighth of an inch (1.6 to 3 mm) in diameter. The tool may be integrated with a transducer; the diameter, therefore, need not be determinative. The bonding tool tip itself is, in some embodiments, 3 to 10 mils (0.08 to 0.25 mm) square. In another embodiment, a multi-contact bonding tool may be approximately one-half to three inches (12-80 mm) long and about one-sixteenth to one-eight inches (1.6 to 3 mm) in diameter. The bonding tool tips may be from 3 to 12 mils (0.08 to 0.30 mm) by 20 to 30 mils.

A two-contact bonding tool may be approximately one-half inch (12-13 mm) long and about one-sixteenth inch (1.6 mm) in diameter or a larger size of up to 3 inches long and approximately one-eighth in diameter. The bonding tool tips may be from 3 to 10 mils (0.08 to 0.25 mm) by 16 to 33 mils. The tool, in one embodiment, is long enough to be able to bond more than one TAB and small enough to fit in the window of the flex.

The bonding tool may be configured to cut, guide, shape, and bond leads to the bond pads of an integrated circuit chip in orthogonal and radial directions. The length and width of the tool may be determined, in some embodiments, by the need for the tool to bring the leads from a top surface across the thickness of an elastomer to the bonding leads or bond pads. In addition, the occurrence of heel cracks often caused by poor design and finishing, may be minimized to prevent pre-matured failures.

The high stiffness and high abrasion resistance requirements of the present invention are, in one embodiment suited for ceramics (e.g., electrical non-conductors) or metals such as tungsten carbide (e.g., electrical conductors). The bonding tip may have a Rockwell hardness of approximately 85 or above and last for approximately 15,000 bonding cycles. Alternative Rockwell hardness and bonding cycle endurance ranges may be utilized in various embodiments of the invention dependent upon particular manufacturer or end-user requirements.

Tools may be made from a uniform extrinsic semi-conducting material, which has dopant atoms in appropriate concentration and valence states to produce sufficient mobile charge carrier densities that will result in electrical conduction in a desired range. Polycrystalline silicon carbide uniformly doped with boron is an example of such a uniform extrinsic semi-conducting material.

Tools may be made by forming a thin layer of a highly doped semiconductor on an insulating core. In this configuration, the core provides the mechanical stiffness. The semiconductor surface layer provides abrasion resistance and a charge carrier path from tip to mount that will permit dissipation of electrostatic charge at an acceptable rate. A diamond tip wedge that is ion implanted with boron is an example of such a thin layered tool.

Tools may also be made by forming a lightly doped semi-conductor layer on a conducting core. The conducting core provides mechanical stiffness while the semi-conductor layer provides abrasion resistance and a charge carrier path from tip to conducting core, which is electrically connected to the mount. A doping level is chosen to produce conductivity through the layer, which will permit dissipation of electrostatic charge at an acceptable rate. A cobalt-bonded tungsten carbide coated with titanium nitride carbide is an example of such a lightly doped tool.

To avoid damaging delicate electronic devices by an electrostatic discharge, the bonding tool may be electro-static discharge (ESD) safe. The resistance may be high enough so that if it is not a conductor as to stop all transient from flowing through the tool to the device.

Multi-head-contact and multi-contact TAB bonding tools may be manufactured through the use of mixing, molding, and sintering reactive powders. Hot pressing reactive powders may also be used. The use of fusion casting is also an option for manufacture.

Through the use of mixing, molding, and sintering reactive powders—for example, alumina (Al2O3), zirconia (Zr2O3), iron oxide (FeO2), or titanium oxide (Ti2O3)—fine particles (e.g., a half of a micron in size) of a desired composition may be mixed with organic and inorganic solvents, dispersants, binders, and sintering aids. The binder and/or the sintering aids could be any of, any combination of, or all of magnesia, yttria, boron, carbon colloidal silica, alumina solvents, ethyl silicate, any phosphate, any rare earth metal oxide, or yttrium. Solvents, too, could be any of the aforementioned elements, compounds, or combination in addition to H2O, for example.

The mixture may then be molded into oversized wedges. The wedges may be dried and slowly heated to remove binders and dispersants. In one embodiment, the wedges are heated to a temperature between 500-2500 degrees Celsius.

The wedges may then be heated to a high enough temperature so that the individual particles sinter together into a solid structure with low porosity. In one embodiment, the wedges are heated to at least a temperature of 4000 degrees Celsius. The heat-treating atmosphere is chosen to facilitate the removal of the binder at a low temperature and to control the valence of the dopant atoms at the higher temperature and while cooling. After cooling, the wedges may be machined to achieve required tolerances.

The wedges may then be treated to produce a desired surface layer (e.g., 100 to 1000 angstroms thick) by ion implementation, vapor deposition, chemical vapor deposition, physical deposition, electroplating deposition, neutron bombardment, or combinations of the above. The pieces may be subsequently heat treated in a controlled atmosphere (e.g., 2000 to 2500 degrees Celsius for 3 to 5 minutes) to produce desired layer properties through diffusion, re-crystallization, dopant activation, or valence changes of metallic ions.

Through the use of hot pressing reactive powders—like those disclosed above—fine particles of a desired composition are mixed with binders and sintering aids, like those disclosed above. These mixtures may be used to produce a multi-head-contact tool or multi-contact TAB tool as described herein. The mixture is then pressed in a mold at a high enough temperature (e.g., 1000 to 4000 degrees Celsius) to cause consolidation and binding of the individual particles into a solid structure with low porosity (e.g., having grain size of less than half a micron in size). In one embodiment, the temperature is between 1000 and 2500 degrees Celsius. The hot pressing atmosphere is chosen to control the valence of the dopant atoms.

After cooling and removal from the hot press, the pieces may be machined to achieve required tolerances. The pieces may then be treated to produce a desired surface layer by ion Implementation, vapor deposition, chemical vapor deposition, physical deposition, electo-plating deposition, neutron bombardment, or combinations of the above.

The pieces may subsequently be heat treated in a controlled atmosphere to produce desired layer properties through diffusion, re-crystallization, dopant activation, or valence changes of metallic ions.

Bonding tools may also be manufactured through fusion casting. Through fusion casting, metals of a desired composition are melted in a non-reactive crucible before being cast into an ingot. The ingot is then rolled, extruded, drawn, pressed, heat-treated (e.g., at 1000 degrees Celsius or 500 degrees Celsius to 2500 degrees Celsius for one to two hours) in a suitable atmosphere, and chemically treated.

The rolling, extruding, drawing, and pressing steps shape the tip, while heat treatment and chemical treatment steps affect or impart mechanical and electrical properties such as hardness and resistivity.

The pieces may then be machined to achieve required tolerances. The metallic pieces may also be treated to produce a desired surface layer by vapor deposition, chemical vapor deposition, physical deposition, electroplating deposition, or combinations of the above.

The pieces may subsequently be heat-treated (e.g., 4000 degrees Celsius for three to four hours) in a controlled atmosphere to produce desired layer properties through diffusion, re-crystallization, dopant activation, or valence changes of metallic ions.

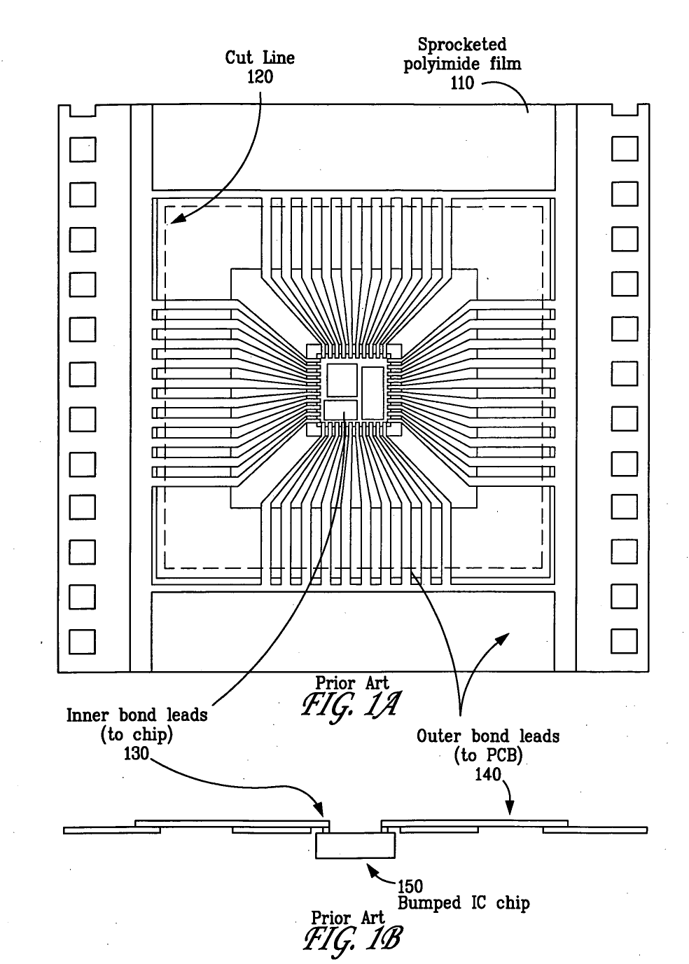

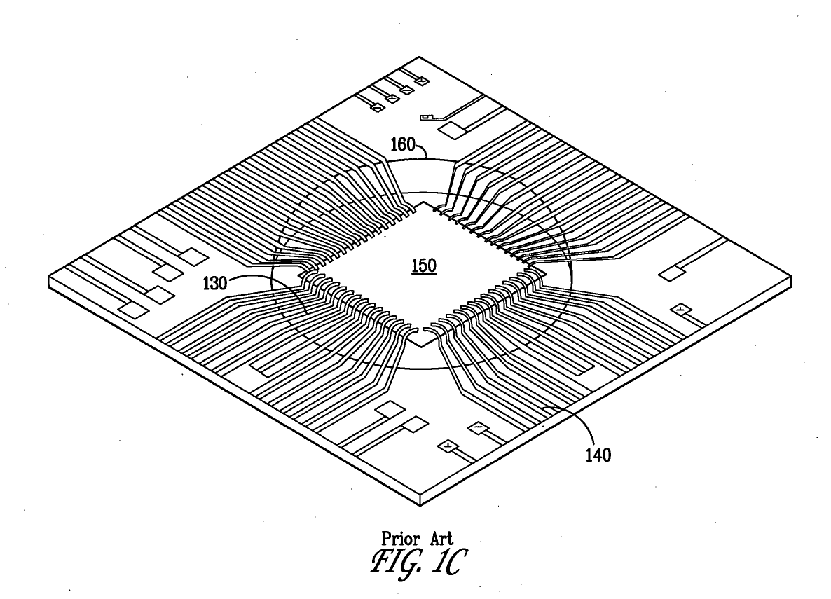

The present invention further provides that the layer used in the bonding process may be the following composition of matter; for example, a formula of dissipated ceramic comprising alumina (aluminum oxide Al2O3) and zirconia (zirconium oxide ZrO2) and other elements. This mixture can be both somewhat electrically conductive and insulative and mechanically durable. The multi-contact TAB bonding tool head will be coated with this material or it could be made completely out of this material. The shape of the head may be as shown and described in earlier FIG. 1.

The TAB bonding tool of the present invention may be used for any number of different types of bonding; for example, ultrasonic and thermal flip chip bonding.

While the present invention has been described with reference to exemplary embodiments, it will be understood by those skilled in the art that various changes may be made and equivalents may be substituted for elements thereof without departing from the true spirit and scope of the present invention. In addition, modifications may be made without departing from the essential teachings of the present invention.

1. A bonding tool for use in tape automated bonding (TAB), the bonding tool comprising a plurality of TAB bonding heads, wherein the TAB bonding tool is ESD safe so as not to damage the device.

2. The bonding tool of claim 1, wherein the tool is configured to bond a plurality of TABs in a single bonding operation.

3. (canceled)

4. The bonding tool of claim 1, wherein one or more of the TAB bonding heads has an insulative core.

5. The bonding tool of claim 1, wherein one or more of the TAB bonding heads has a resistance of less than 5×10¹ ohms.

6. The bonding tool of claim 1, wherein one or more of the TAB bonding heads has a resistance of greater than 5×10¹ ohms.

7. The bonding tool of claim 1, wherein one or more of the TAB bonding heads is constructed of a carbide.

8. The bonding tool of claim 1, wherein the tool is of sufficient durability and hardness to avoid the heed for regular replacement

9. The bonding tool of claim 1, wherein the tool is configured for use with a head stack assembly.

10. The bonding tool of claim 1, wherein one or more of the TAB bonding heads include a double cross groove configuration.

11. The bonding tool of claim 1, wherein one or more of the TAB bonding heads include a single cross groove configuration.

12. The bonding tool of claim 1, wherein one or more of the TAB bonding heads include a protruding V configuration.

13. The bonding tool of claim 1, wherein one or more of the TAB bonding heads include a waffle configuration.

14. The bonding tool of claim 1, wherein one or more of the TAB bonding heads are configured to bond at least one lead to a bond pad in an orthogonal direction.

15. The bonding tool of claim 1, wherein one or more of the TAB bonding heads are configured to bond at least one lead to a bond pad in a radial direction.

16. The bonding tool of claim 1, wherein one or more of the TAB bonding heads are constructed of a ceramic.

17. The bonding tool of claim 1, wherein one or more of the TAB bonding heads are constructed of a uniform extrinsic semi-conducting material comprising dopant atoms in a concentration and valence state sufficient to produce a mobile charge carrier density resulting in electrical conduction within a predetermined range.

18. The bonding tool of claim 17, wherein the material comprises a polycrystalline silicon carbide uniformly doped with boron.

19. The bonding tool of claim 1, wherein one or more of the TAB bonding heads are constructed of a highly doped semiconductor on an insulating core providing abrasion resistance and a charge carrier path permitting dissipation of an electrostatic charge at a predetermined rate.

20. The bonding tool of claim 1, wherein one or more of the TAB bonding heads are constructed of a lightly doped semi-conductor on a conducting core providing mechanical stiffness, abrasion resistance, and a charge carrier path.

21. The bonding tool of claim 20, wherein a doping level of the semi-conductor is chosen to produce conductivity that permits dissipation of an electrostatic charge at a predetermined rate.

22. The bonding tool of claim 1, wherein one or more of the TAB bonding heads are manufactured through the mixing, molding, and sintering of reactive powders.

23. The bonding tool of claim 1, wherein one or more of the TAB bonding heads are manufactured through hot pressing reactive powders.

24. The bonding tool of claim 1, wherein one or more of the TAB bonding heads are manufactured through fusion casting.

25. The bonding tool of claim 1, wherein one or more of the TAB bonding heads are large enough to bond more than one TAB but small enough to fit within a window formed in a flex on a Head Stack Assembly (HSA).

26. A method for increasing the speed of bonding the head stack assembly (HSA) to the head gimbal assembly (HGA) interconnection in a Hard Disk Drive by allowing an increased number of bonds notwithstanding ESD, the method comprising:
providing a multi-head-contact bonding tool for use in tape automated bonding (TAB), the multi-head-contact bonding tool having a plurality of TAB bonding heads to bond a plurality of TABs in a single bonding operation thereby shortening a production cycle time through increased throughput rate; and
bonding the HSA to the HGA using the multi-head-contact bonding tool, wherein the multi-head-contact bonding tool is ESD safe.

27-28. (canceled)

29. The method of claim 26, wherein one or more of the TAB bonding heads have an insulative core.

30. The method of claim 26, wherein one or more of the TAB bonding heads have a resistance of less than 5×10¹ ohms.

31. The method of claim 26, wherein one or more of the TAB bonding heads have a resistance of greater than 5×10¹ ohms.

32. The method of claim 26, wherein one or more of the TAB bonding heads is constructed of a carbide.

33. (canceled)

34. The method of claim 26, wherein one or more of the TAB bonding heads is selected from the group consisting of a double cross groove configuration, a single cross groove configuration, a protruding V configuration, and a waffle configuration.

35-37. (canceled)

38. The method of claim 26, wherein bonding occurs in an orthogonal direction.

39. The method of claim 26, wherein bonding occurs in a radial direction.

40. (canceled)

41. The method of claim 26, wherein a mobile charge carrier results in electrical conduction within a predetermined range.

42. (canceled)

43. The method of claim 26, wherein a charge carrier path permits dissipation of an electrostatic charge at a predetermined rate.

44-48. (canceled)

49. The method of claim 26, wherein more than one TAB is banded while fitting within a window formed in a flex on a Head Stack Assembly (HSA).

50-52. (canceled)
